(19) United States
(12) Patent Application Publication
(10) Pub. No.: US 2026/0343139 A1
(43) Pub. Date: Oct. 29, 2026

(54) Low-Resonance Shell and Electronic Device

(71) Applicant: SSI NEW MATERIAL (ZHENJIANG) CO., LTD., Zhenjiang (CN)

(72) Inventors: Mingbo GUO, Zhenjiang (CN); Zhendan ZHANG, Zhenjiang (CN); Zhenzhen WANG, Zhenjiang (CN); Lei ZHANG, Zhenjiang (CN); Yuanhong MA, Zhenjiang (CN)

(21) Appl. No.: 19/484,459

(22) PCT Filed: May 14, 2024
(86) PCT No.: PCT/CN2024/093054

§ 371 Date: Nov. 14, 2025

(30) Foreign Application Priority Data
May 16, 2023 (CN) 202321175725.5

(51) Int. Cl. H04R 1/28

(52) U.S. Cl. CPC H04R 1/288; H04R 2201/029; H04R 2400/11; H04R 2499/11; H04R 2499/15

(57) ABSTRACT

A low-resonance shell and an electronic device. The low-resonance shell includes a housing, an acoustic transducer, and a vibration absorbing medium. An accommodation cavity for accommodating a functional module is formed inside the housing, and a sound outlet is disposed on a side wall of the housing. The acoustic transducer is disposed in the accommodation cavity, and a sound leading tube is disposed between the acoustic transducer and the sound output hole. A filling gap is formed between the acoustic transducer, the functional module, and the inner wall of the housing. The vibration absorbing medium is located within the filling gap.

### RELATED APPLICATION

The present disclosure claims priority to Chinese Utility Model Patent Application No. 202321175725.5, filed on May 16, 2023, and entitled “low-resonance shell and electronic device”.

### TECHNICAL FIELD

The present disclosure relates to the field of acoustoelectric technologies, and in particular to a low-resonance shell and an electronic device.

### BACKGROUND

In modern mainstream electronic devices, the pursuit of the high-quality audio performance from acoustic transducers (speakers or receivers) has led to non-sealed rear chambers thereof, allowing airflow into internal acoustic chambers of devices through sound outlets at rear ends of the speakers. However, turbulent airflow frequently induces resonance of the device's shell, resulting in perceptible vibrations when a user holds the shell. The vibrations intensify with increasing sound volume, ultimately compromising user experience. Consequently, designing optimized acoustic chamber structures of the electronic devices to enhance holding comfort remains a critical challenge requiring urgent resolution.

### SUMMARY

The present disclosure aims to provide a low-resonance shell and an electronic device, which can solve the problem of the resonance of the shell of the electronic device caused by airflow turbulence when an acoustic transducer is in operation, and reduce the impact of the airflow on the shell, thereby reducing the resonance of the electronic device and optimizing user experiences.

The above objective of the present disclosure is mainly achieved by the following technical solutions.

In one aspect, the present disclosure provides a low-resonance shell, which includes a housing, an acoustic transducer, and a vibration absorption medium. An accommodation cavity for accommodating a functional module is formed inside the housing, and a sound outlet is disposed on a side wall of the housing. The acoustic transducer is disposed in the accommodation cavity, with a sound leading tube disposed between the acoustic transducer and the sound outlet. A filling gap is formed between the acoustic transducer, the functional module, and an inner wall of the housing. The vibration absorption medium is located within the filling gap.

In another aspect, the present disclosure further provides an electronic device, which includes a display module, and the aforementioned low-resonance shell disposed at a rear side of the display module. The housing includes a middle frame and a back cover which are connected to each other. The functional module and the acoustic transducer are fixed in the middle frame, and the display module is connected to the middle frame.

Compared with the prior art, the technical solutions according to the present disclosure have the following characteristics and advantages.

1. In the low-resonance shell according to the present disclosure, the vibration absorption medium is filled in the housing of the electronic device, which can reduce the impact of internal airflow on the housing of the electronic device, thereby reducing the resonance of the electronic device, optimizing the user experience, and enhancing the competitiveness of the electronic device in the market.

2. In the low-resonance shell according to the present disclosure, a support structure facing the filling gap is disposed on the housing, and the support structure abuts against each functional module in the housing, so that the deformation of the shell caused by airflow impact can be reduced, and at the same time, the support structure can support and fix the vibration absorption medium.

### BRIEF DESCRIPTION OF THE DRAWINGS

The following drawings are only intended for schematic illustration and explanation of the present disclosure, and do not limit the scope of the present disclosure. In the drawings:

FIG. 1 illustrates a structural diagram of a low-resonance shell according to an embodiment of the present disclosure.

FIG. 2 illustrates a transmission of gas vibration in a filling gap when an acoustic transducer according to the present disclosure is in operation.

FIG. 3 illustrates a structural diagram of a low-resonance shell according to another embodiment of the present disclosure.

FIG. 4 illustrates a structural diagram of a low-resonance shell according to still another embodiment of the present disclosure.

FIG. 5 illustrates a structural diagram of an electronic device according to the present disclosure.

Reference numerals:
10: housing; 11: middle frame; 12: back cover; 13: sound outlet; 20: functional module;
30: vibration absorption medium; 31: vibration absorption package; 40: support strip;
50: acoustic transducer; 51: speaker unit; 511: front sound cavity structure;
52: receiver unit; 60: sound leading tube; 70: filling gap; 80: damping adhesive;
90: display module.

### DETAILED DESCRIPTION OF THE EMBODIMENTS

Embodiments of the present disclosure are described below through specific examples, and those skilled in the art can easily understand other advantages and effects of the present disclosure from the specification. In addition, the present disclosure can also be implemented or applied through other different specific embodiments, and various modifications and variations can be made within the protection scope of the present disclosure.

According to the above advantages, in order to further understand the present disclosure, preferred embodiments are disclosed as follows, and the technical solutions of the present disclosure and the effects achieved thereby are described in detail below with reference to the drawings.

### Embodiment 1

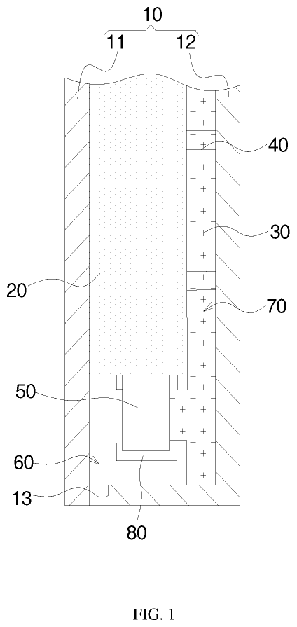

As illustrated in FIGS. 1 to 3, the present disclosure provides a low-resonance shell, which includes a housing 10, an acoustic transducer 50, and a vibration absorption medium 30. An accommodation cavity for accommodating a functional module 20 is formed in the housing 10, and a sound outlet 13 is provided on a side wall of the housing 10. The acoustic transducer 50 is disposed in the accommodation cavity, with a sound leading tube 60 provided between the acoustic transducer 50 and the sound outlet 13. A filling gap 70 is formed between the acoustic transducer 50, the functional module 20, and an inner wall of the housing 10. The vibration absorption medium 30 is disposed within the filling gap 70.

In the low-resonance shell according to the present disclosure, the vibration absorption medium 30 is filled in a gap where airflow is turbulent inside the housing 10. The vibration absorption medium 30 can effectively absorb the airflow generated inside the housing 10 when the acoustic transducer 50 is in operation, so as to prevent the resonance of the housing 10 caused by airflow turbulence, thereby optimizing the holding experience of the housing 10.

Specifically, as illustrated in FIG. 1, the housing 10 includes a middle frame 11 and a back cover 12 connected to each other, and the accommodation cavity is formed between the middle frame 11 and the back cover 12. The functional module 20 is fixed on the middle frame 11 and located within the accommodation cavity. The functional module 20 may include common components found in electronic devices, such as a processor module, a lens module, a battery module, etc. However, it is not limited to these examples. Any structure fixed on the middle frame 11 and having a gap between itself and the back cover 12 may be considered as the functional module 20.

The acoustic transducer 50, serving as a common sound-emitting module or receiver module in electronic devices, is fixed on the middle frame 11. The housing 10 is provided with the sound outlet 13, and the sound leading tube 60 is connected between the sound outlet 13 and the sound transducer 50. In this embodiment, the sound outlet 13 is provided on the back cover 12, but is not limited thereto. In other embodiments, the location of the sound outlet 13 may be determined according to practical requirements, as long as the sound transducer 50 can be ensured to be in communication with the outside through the sound leading tube 60 and the sound outlet 13.

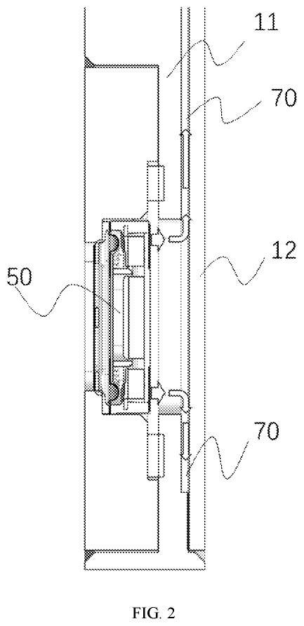

As illustrated in FIG. 1, the filling gap 70 is formed between the acoustic transducer 50, the functional module 20, and the inner wall of the back cover 12, and the vibration absorption medium 30 is disposed within the filling gap 70. As illustrated in FIG. 2, when the acoustic transducer 50 is in operation, its open rear cavity faces the back cover 12. During operation, the airflow generated by vibration passed through the sound vent holes at the rear and enters the filling gap 70. Due to the presence of the vibration absorption medium 30, the vibration transferred by the airflow is absorbed, preventing the vibrating airflow from inducing resonance in the back cover 12, thereby significantly enhancing the user's hand-held experience, especially when the user is making a call or playing audio or video.

According to an embodiment of the present disclosure, the vibration absorption medium 30 is a vibration absorption sheet sandwiched in the filling gap 70. Alternatively, the vibration absorption medium 30 is a vibration absorption coating layer formed on a side wall of the filling gap 70 by coating or adhering.

Specifically, in a feasible embodiment of the present disclosure, the vibration absorption medium 30 is vibration absorption sheets, which are sheet-like structures with certain flexibility. During installation of the rear cover 12, the vibration absorption sheets are sandwiched between the back cover 12 and the functional module 20 fixed on the middle frame 11. In another feasible embodiment of the present disclosure, the vibration absorption medium 30 is a vibration absorption coating layer, which is formed on the side wall of the filling gap 70 by dipping, coating or adhering. The vibration absorption coating layer may be formed on either the inner wall of the back cover 12 or a side of the functional module 20 facing the filling gap 70.

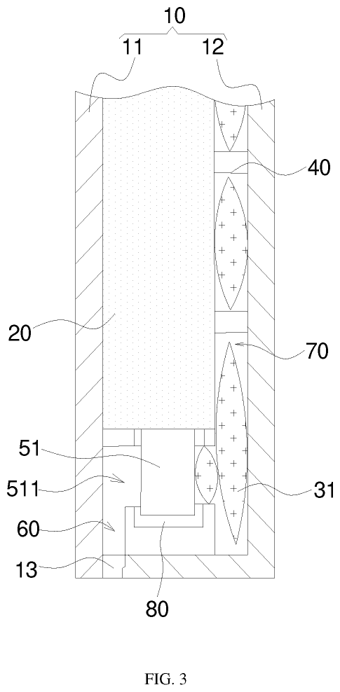

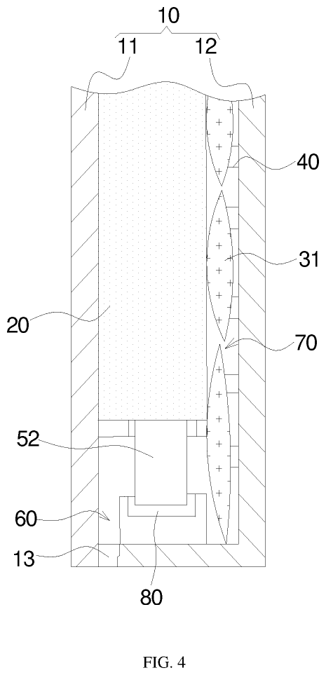

According to an embodiment of the present disclosure, as illustrated in FIGS. 3 and 4, the vibration absorption medium 30 is a granular or sheet-like structure containing zeolite and a matrix material. The granular vibration absorption medium 30 is wrapped by a breathable mesh to form a vibration absorption package 31, which is sandwiched in the filling gap 70.

Specifically, the zeolite may be combined with the matrix material by methods such as spraying. For example, when the matrix material is of a granular or sheet-like structure, firstly, a uniformly dispersed suspension is obtained by mixing zeolite particles, an adhesive, and a solvent; then the suspension is mixed with the granular matrix material by dipping or spraying, or the suspension is sprayed and dipped on the surface of the sheet-like matrix material; and then the resulting product is dried and cured to obtain the final product, i.e., the granular or sheet-like vibration absorption medium 30.

Further, the matrix material is sound absorption cotton (e.g., glass fiber, polyester fiber, centrifugal glass wool, rock wool, mineral wool, plant fiber spray, etc.), foam (e.g., polyurethane, etc.), a carbon skeleton, or an organic skeleton, etc.

In this embodiment, as illustrated in FIG. 3, the granular vibration absorption medium 30 is wrapped by the breathable mesh to form the vibration absorption package 31, during installation of the back cover 12, the vibration absorption package 31 is sandwiched between the back cover 12 and the functional module 20 that is fixed on the middle frame 11.

According to an embodiment of the present disclosure, an inner side of the housing 10 is provided with a support structure, which is at least one support strip 40 connected to the inner side of the housing 10, and the support bar 40 is located within the filling gap 70.

In the embodiment of the present disclosure, the free end of the support strip 40 abuts against the functional module 20. On one hand, this can reduce deformation of the back cover 12 caused by airflow impact and reduce the resonance; on the other hand, a plurality of support strips 40 of the support structure can fix the vibration absorption sheets or the vibration absorption packages 31 inside the filling gap 70, preventing them from moving in the filling gap 70.

Specifically, as illustrated in FIG. 1, when the back cover 12 is connected to the middle frame 11, the support strip 40 abut against the various functional modules 20 located on the middle frame 11, thus reducing deformation of the back cover 12 caused by airflow impact and reduce the resonance. As illustrated in FIG. 3, in this embodiment, the support strips 40 partition the filling gap 70 into a plurality of separate gap spaces, and a plurality of vibration absorption packages 31 containing the vibration absorption media 30 are respectively disposed within these gap spaces. As illustrated in FIG. 4, in this embodiment, the support strips 40 press the plurality of vibration absorption packages 31 tightly against the respective functional modules 20 to secure them in place.

In this embodiment, the support strips 40 connected to different positions on the back cover 12 have the same initial height and achieve tight contact with the functional modules 20 during the assembly of the back cover 12. In an exemplary embodiment, since the functional modules 20 located at different positions on the middle frame 11 have different thicknesses, the support strips 40 at different locations can be designed with different heights. Such height variation facilitates the assembly of the back cover 12.

In this embodiment, the support strips 40 connected to the back cover 12 are made of a rigid material, such as hard plastic. In an exemplary embodiment, the support strips 40 connected to the back cover 12 may be made of an elastic material, such as foam. The elastic support strips 40 are conducive to the assembly and fitting of the back cover 12.

According to an embodiment of the present disclosure, the vibration absorption medium 30 is disposed in a space of the filling gap 70 corresponding to an area on the housing 10 where a vibration acceleration is more than 8 m/s² during operation of the acoustic transducer 50. Conversely, no vibration absorption medium 30 is disposed in a space of the filling gap 70 corresponding to an area on the housing 10 where the vibration acceleration is not more than 8 m/s² during operation of the acoustic transducer 50.

In the present disclosure, the vibration absorption medium 30 is filled only in the area inside the filling gap 70 that are significantly affected by the airflow generated during the operation of the acoustic transducer 50, while an area less affected is left unfilled. This approach, on the one hand, reduces the amount of the vibration absorption medium 30 used, reducing costs, and on the other hand, reduces the weight of the electronic device with the low-resonance shell, preventing a poor user experience caused by excessive weight of the electronic device.

Specifically, in this embodiment, a mobile phone may be used as the electronic device to be tested, an acceleration sensor is tightly attached to an area on a back cover of the mobile phone to be tested through an adhesive tape, the mobile phone is placed at the center of a foam pad, the sensor's wires are straightened, keeping them in a natural state without tension or bending, while ensuring the wires do not touch the phone. During testing, the operator should avoid bumping or pressing the desk. The mobile phone is set to maximum volume, and a sound source is played on loop. After the music has played for more than 20 seconds, readings are taken. Each reading duration should exceed 10 seconds, and the stable vibration acceleration value during the reading period is recorded, which represents the vibration acceleration in the measurement area of the acceleration sensor on the mobile phone's back cover. Repeating the above process, after testing the vibration acceleration in different areas across the entire back cover of the mobile phone, the vibration absorption medium 30 is filled in the space of the filling gap 70 on the inner side of the back cover that corresponds to area where the vibration acceleration exceeds 8 m/s². Other space of the filling gap 70 are left unfilled with the vibration absorption medium 30.

Exemplarily, the vibration absorption medium 30 is disposed in a space of the filling gap 70 corresponding to an area on the housing 10 where the vibration acceleration is more than 10 m/s² during operation of the acoustic transducer 50, and no vibration absorption medium 30 is disposed in a space of the filling gap 70 corresponding to an area on the housing 10 where the vibration acceleration is not more than 10 m/s² during operation of the acoustic transducer 50. According to an embodiment of the present disclosure, as illustrated in FIG. 3, the acoustic transducer 50 is a speaker unit 51, a front part of a diaphragm of the speaker unit 51 is provided with a front sound cavity structure 511 communicated with the sound leading tube 60. The sound leading tube 60 and the front sound cavity structure 511 are integrally formed with the housing 10. Alternatively, the sound leading tube 60 and the front sound cavity structure 511 are integrally formed as an independent member and the independent member is connected to the speaker unit 51.

Specifically, in this embodiment, the front sound cavity structure 511 and the sound leading tube 60 are integrally formed on the middle frame 11 at a position corresponding to a position where the speaker unit 51 is fixed on the middle frame 11. When the speaker unit 51 is fixed on the middle frame 11, the front part of the diaphragm of the speaker unit 51 is corresponding to the front sound cavity structure 511 on the middle frame 11, and a front part of the speaker unit 51 is hermetically connected to the front sound cavity structure 511. The sound outlet 13 on the back cover 12 is corresponding to the sound leading tube 60. When the speaker unit 51 is in operation, the sound passes through the front sound cavity structure 511 and the sound leading tube 60 and then comes out of the sound output hole 13. In other embodiments of the present disclosure, the front sound cavity structure 511 and the sound leading tube 60 may be separate members, which are connected to the speaker unit 51 after being manufactured and molded, and then fixed to the middle frame 11 together with the speaker unit 51.

Further, the speaker unit 51 and the front sound cavity structure 511 may be hermetically connected to each other by bonding, welding, riveting, or snapping.

Exemplarily, a joint between the speaker unit 51 and the front sound cavity structure 511 is covered by a damping adhesive 80, which is polyurethane adhesive, epoxy resin adhesive, or a combination of polyurethane adhesive and epoxy resin adhesive. The damping adhesive 80 can reduce the vibration transmission between the speaker unit 51 and other members during operation.

According to an embodiment of the present disclosure, as illustrated in FIG. 4, the acoustic transducer 50 is a receiver unit 52, and a front part of a diaphragm of the receiver unit 52 is communicated with the sound leading tube 60. The sound leading tube 60 is integrally formed with the housing 10. Alternatively, the sound leading tube 60 is connected to the receiver unit 52 as an independent member.

Specifically, in this embodiment, the sound leading tube 60 is integrally formed on the middle frame 11 at a position corresponding to a position where the receiver unit 52 is fixed on the middle frame 11. When the receiver unit 52 is fixed on the middle frame 11, the front part of the diaphragm of the receiver unit 52 is corresponding to the sound leading tube 60 on the middle frame 11, a front part of the receiver unit 52 is hermetically connected to the sound leading tube 60, and the sound outlet 13 on the back cover 12 is corresponding to the sound leading tube 60. When the receiver unit 52 is in operation, sound enters the sound outlet 13 and is transmitted to the receiver unit 52 through the sound leading tube 60. In other embodiments of the present disclosure, the sound leading tube 60 is a separate member, which is connected to the receiver unit 52 after being manufactured and molded, and then fixed to the middle frame 11 together with the receiver unit 52.

Further, the receiver unit 52 and the sound leading tube 60 are hermetically connected to each other by bonding, welding, riveting or snapping.

Exemplarily, a joint between the receiver unit 52 and the sound leading tube 60 is covered a damping adhesive 80, which is polyurethane adhesive, epoxy resin adhesive, or a combination of polyurethane adhesive and epoxy resin adhesive. The damping adhesive 80 can reduce the vibration transmission between the receiver unit 52 and other members during operation.

### Embodiment 2

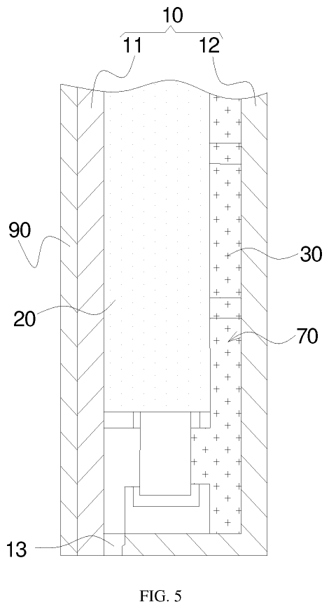

As illustrated in FIG. 5, the present disclosure further provides an electronic device, which includes a display module 90, and the low-resonance shell as described in Embodiment 1 disposed at a rear side of the display module 90. The housing 10 includes a middle frame 11 and a back cover 12 connected to each other. The functional module 20 and the acoustic transducer 50 are fixed in the middle frame 11, and the display module 90 is connected to the middle frame 11.

Specifically, the electronic device may be any device including the aforementioned low-resonance shell, such as a mobile phone, a stereo device, a notebook computer, a tablet computer, a teleconference device, a wearable device or an AR/VR device, an automobile, or a smart home appliance, which is not specifically limited herein.

Those described above are only examples for the convenience of explanation, and the scope of rights claimed in the present disclosure should be based on the scope of the claims, rather than being limited to the above embodiments.

1. A low-resonance shell, comprising:
a housing, wherein an accommodation cavity for accommodating a functional module is formed in the housing, and a sound outlet is provided on a side wall of the housing;
an acoustic transducer disposed in the accommodation cavity, with a sound leading tube provided between the acoustic transducer and the sound outlet, wherein a filling gap is formed between the acoustic transducer, the functional module, and an inner wall of the housing; and
a vibration absorption medium disposed within the filling gap.

2. The low-resonance shell according to claim 1, wherein the vibration absorption medium is a vibration absorption sheet sandwiched in the filling gap; or the vibration absorption medium is a vibration absorption coating layer formed on a side wall of the filling gap by coating or adhering.

3. The low-resonance shell according to claim 1, wherein the vibration absorption medium is a granular or sheet-like structure containing zeolite and a matrix material, wherein the granular vibration absorption medium is wrapped by a breathable mesh to form a vibration absorption package, which is sandwiched in the filling gap.

4. The low-resonance shell according to claim 3, wherein the matrix material is sound absorption cotton, foam, a carbon skeleton, or an organic skeleton.

5. The low-resonance shell according to claim 4, wherein an inner side of the housing is provided with a support structure, which is at least one support strip connected to the inner side of the housing, and the at least one support bar is located within the filling gap.

6. The low-resonance shell according to claim 1, wherein the acoustic transducer is a speaker unit, a front part of a diaphragm of the speaker unit is provided with a front sound cavity structure communicated with the sound leading tube;
wherein the sound leading tube and the front sound cavity structure are integrally formed with the housing; or, the sound leading tube and the front sound cavity structure are integrally formed as an independent member and the independent member is connected to the speaker unit.

7. The low-resonance shell according to claim 6, wherein the speaker unit and the front sound cavity structure are hermetically connected to each other by bonding, welding, riveting or snapping.

8. The low-resonance shell according to claim 7, wherein a joint between the speaker unit and the front sound cavity structure is covered by a damping adhesive, which is polyurethane adhesive, epoxy resin adhesive, or a combination of polyurethane adhesive and epoxy resin adhesive.

9. The low-resonance shell according to claim 1, wherein the acoustic transducer is a receiver unit, and a front part of a diaphragm of the receiver unit is communicated with the sound leading tube;
wherein the sound leading tube is integrally formed with the housing; or the sound leading tube, serving as an independent member, is connected to the receiver unit.

10. The low-resonance shell according to claim 9, wherein the receiver unit and the sound leading tube are hermetically connected to each other by bonding, welding, riveting or snapping.

11. The low-resonance shell according to claim 10, wherein a joint between the receiver unit and the sound leading tube is covered by a damping adhesive, which is polyurethane adhesive, epoxy resin adhesive, or a combination of polyurethane adhesive and epoxy resin adhesive.

12. The low-resonance shell according to claim 1, wherein the vibration absorption medium is disposed in a space of the filling gap corresponding to an area on the housing where a vibration acceleration is more than 8 m/s² during operation of the acoustic transducer.

13. An electronic device, comprising a display module, and a low-resonance shell disposed at a rear side of the display module;
wherein the low-resonance shell comprises:
a housing, wherein an accommodation cavity for accommodating a functional module is formed in the housing, and a sound outlet is provided on a side wall of the housing;
an acoustic transducer disposed in the accommodation cavity, with a sound leading tube provided between the acoustic transducer and the sound outlet, wherein a filling gap is formed between the acoustic transducer, the functional module, and an inner wall of the housing; and
a vibration absorption medium disposed within the filling gap;
wherein the housing comprises a middle frame and a back cover which are connected to each other, the functional module and the acoustic transducer are fixed in the middle frame, and the display module is connected to the middle frame.
